(19) United States
(12) Patent Application Publication
(10) Pub. No.: US 2016/0150828 A1
(43) Pub. Date: Jun. 2, 2016

(54) VAPORIZING RESERVOIR

(71) Applicants: Gabriel Marc Goldstein, Beverly Hills, CA (US); Gabriel Marc Goldstein, Beverly Hills, CA (US)

(72) Inventors: Gabriel Marc Goldstein, Beverly Hills, CA (US); Pieter Hans Schouten, Berkeley, CA (US); Richard Dale Hart, Bedford, NH (US)

(73) Assignee: Gabriel Marc Goldstein, Beverly Hills, CA (US)

(21) Appl. No.: 14/957,295

(22) Filed: Dec. 2, 2015

Related U.S. Application Data
(60) Provisional application No. 62/086,519, filed on Dec. 2, 2014.

(51) Int. Cl. A24F 47/00; H05B 3/00; H05B 6/36

(52) U.S. Cl. CPC A24F 47/008; H05B 6/36; H05B 3/0014

(57) ABSTRACT

A vaporizing reservoir including a containment vessel having a first shaft port exposed to ambient and one or more sidewalls defining a body portion having an interior cavity and a vaporizing portion communicated to the interior cavity; an inductive coil disposed within the vaporizing portion, the inductive coil electrically disconnected outside of the containment vessel and configured for inductive heating; and an air shaft communicated to the vaporizing portion and extending to the first shaft port. Fluid or solid material may be present in the interior cavity for vaporization. For fluid material, a wick may be included with the inductive coil to facilitate communication of the material to the inductive coil. An exterior inductive coil heats the inductive coil within the vaporizing portion and vaporizes the material communicated to the interior inductive coil. Vapor from the heated interior inductive coil is extracted through the air shaft.

### CROSS REFERENCE TO RELATED APPLICATIONS

This application claims benefit of U.S. Patent No. 62/086,519, the contents of which is hereby expressly incorporated in its entirety for all purposes.

### COPYRIGHT OF INVENTION

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### FIELD OF THE INVENTION

The present invention relates generally to vaporizers used in cooperation with material, for example botanical material, and more specifically, but not exclusively, to a vaporizing reservoir, a vaporizer using the vaporizing reservoir, and methods of vaporizing material using the vaporizing reservoir.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

A vaporizer is used to create an inhalable non-combustion product from vaporization of organic material. FIG. 1 illustrates a conventional vaporizer 100 that includes an elongate housing 105 that secures a battery 110, a switch 115, an atomizer 120, and a cartridge 125. A mouthpiece 130 engages housing 105. Cartridge 125 holds a liquid that includes a solution of the organic material to be vaporized.

In operation, electrical energy from battery 110 is delivered to atomizer 120 under control of switch 115. Atomizer 120 creates the inhalable non-combustion product from the solution and the user employs mouthpiece 130 to inhale the product.

There are a number of drawbacks to vaporizer 100. These drawbacks are well-known yet the popularity of vaporizers continues to grow in spite of the limitations. Improvements are made to attempt to reduce the drawback but these improvements have not altered the basic fundamental design of vaporizer 100.

These drawbacks include concerns regarding solution leakage from cartridge 125, tampering with the solution before purchase of cartridge 125, use of a single vaporizer 100 with multiple cartridges 125 storing different organic materials creates not only additional storage/leakage problems for cartridges not installed in housing 105, but because some of product-producing elements of atomizer 120 are reused with each new cartridge, the current structure requires a transition time in which the “old” product is cleared and the “new” product may be produced and enjoyed, after a period of a cross-contaminated product is eliminated, and modifications made to reduce this transition time work counter to a desire of many users to create greater quantities of product per inhalation.

These drawbacks relate to a fundamental design of vaporizer 100 and a predominate design of cartridge 125. Cartridge 125 includes a pair of openings and that atomizer 120 is typically a nichrome heating element that directly heats a portion of the solution to create the vapor. The portion of the solution is delivered to the heating element by use of a wicking element in contact with the solution. This fundamental structure and operation leads to the drawbacks encountered by users.

What is needed is a system and method for improving a user experience with respect to vaporizers and the like.

### BRIEF SUMMARY OF THE INVENTION

Disclosed is a system and method for improving a user experience with respect to vaporizers and the like. The following summary of the invention is provided to facilitate an understanding of some of technical features related to a vaporizing reservoir powered by an energy delivery system and an improved vaporizing system using such a vaporizing reservoir, and is not intended to be a full description of the present invention. A full appreciation of the various aspects of the invention can be gained by taking the entire specification, claims, drawings, and abstract as a whole. The present invention is applicable to other devices, systems, and methods for production of an inhalable non-combustion product from a material within the vaporizing reservoir.

A vaporizing reservoir includes a container having a single opening defining a volume holding the material. When the material moves through a wick (e.g., a structure employing capillary action to move one or more components of the material through the volume), a large diameter cannulated wick is disposed into the volume through the opening and placed in contact with the material having an exposed end accessible at the opening. An electrically conductive element is disposed within the wicking material, for example a conductive coil is woven or otherwise manufactured into the wick. This conductive element is electrically accessible at the exposed end and may extend completely to an opposing end of the wick opposite of the exposed end or terminate intermediate the ends.

As further explained herein, the vaporizing reservoir operates in cooperation with an energy delivery system. In one embodiment of the present invention, the vaporizing reservoir is contemplated to be operable to produce the product using an inductive heating paradigm or a direct heating paradigm. Any particular vaporizer will typically be configured for one of these modes of operation and the vaporizing reservoir is adaptable to be used with either type of vaporizer. A difference between these vaporizers (and the associated paradigms) is that the energy delivery system will be different depending upon which specific paradigm is used.

In an implementation of this dual option paradigm, the vaporizing reservoir is configurable (most preferably automatically configurable by cooperating operation with any particular compatible vaporizer) to operate properly in either of these scenarios. For example, the conductive element may initially be disposed into a closed loop enabled for inductive heating. When installed into a vaporizer using direct heating, the loop may be severed in one or more places to create a topology matching a conventional direct heating coil.

In some situations, the material may not be capable of interoperation with a wicking structure (e.g., a solid not put into a solution or a suspension with a liquid). An alternate version of the vaporizing reservoir allows comminution of the solid to a small enough particle size for operation with the conductive element used for heating.

Some implementations of the vaporizing reservoir may be dedicated to one specific paradigm or class of paradigms resulting in some simplification in implementation while perhaps increasing user complexity.

The vaporizing reservoir, and compatible systems, are able to improve upon conventional cartridges and compatible vaporizers. These improvements may include use of tamper-evident packaging and closure systems for the vaporizing reservoir, reduction of leak risks, greater product volume, and quick changes from one product to another.

Retailers and customers want assurances that the nature and quality of the material within the vaporizing reservoir meet expectations. Offering the material in a vaporizing reservoir with tamper evident packaging and closure systems are able to provide the desired assurances.

Conventional cartridge systems include two openings and the vaporizing reservoir is preferably implemented with one opening. A source of leakage are the openings so the leak risk with the vaporizing reservoir may be reduced as compared to two opening cartridges. Leakage occurs both during transportation of an uninstalled cartridge and during changing cartridges. In both of the cases, the vaporizing reservoir is able to offer lower risks of leakage in these scenarios.

A use of a large diameter wick with the vaporizing reservoir enables formation of a greater quantity of product per inhale action (sometimes referred to a hit or dose) than a conventional cartridge. Some of this is because the conventional systems have become tailored to small diameter wicks (for quick heating). Because a conventional system typically reuses the wick when changing solutions, a smaller wick retains less solution and thus will not take as long to change from one product to another. The vaporizing reservoir packages the wick with the container ensuring that product is not intermingled in the product-forming components when the user switches products and exchanges one vaporizing reservoir with one product for another vaporizing reservoir with a second product.

Some implementations of a vaporizer may include a one-way exit valve on the mouthpiece. The mouthpiece defines a cavity that, in cooperation with the valve, can allow for inhalable product accumulation, pressure equalization, and/or inhibition of unintended venting of inhalable product. The valve may be actuated directly or indirectly, automatically, semi-automatically, or manually, such as by an operator creating a pressure differential on an exterior surface of the valve (e.g., inhaling on the mouthpiece and the like).

Vaporizing reservoirs may be configured for liquid and liquid-like material as well as grinder implementations for comminution of material that include botanical, organic, mineral material, and combinations, compositions, compounds thereof.

Vaporizing reservoirs, and vaporizing systems including the vaporizing reservoirs, may be made safer: 1) a consumable/cartridge style vaporizing reservoirs may either be sold pre-filled with e-liquid/oil or sterilized/empty sealed with a cap/tamper proof cap or with tape/foil or shrink wrapped for consumer protection; 2) there may be a sterilized/empty vaporizing reservoir for the botanical/organic and/or a wax medium that is sealed with a cap/tamper proof cap or with tape/foil or shrink wrapped for consumer protection; 3) the assembly is less prone to leaking during transport or when stored in a pocket, and 4) easier to change out flavors without the user getting the e-liquid or oil on the hands.

Vaporizing reservoirs, and vaporizing systems including the vaporizing reservoirs, may be made more convenient: 1) the vaporizing reservoir wick and coil assembly are an all in one incorporated assembly which makes the assembly less prone to leaking (leaking is a major complaint amongst many e-liquid users of conventional products on the market), 2) no replacement of wicks and coils are needed in the main body/vaporizing pens for they are all incorporated into the vaporizing reservoir, 3) change flavors with ease with no need to wait for one flavor to run out of the wick (or risking what is commonly referred to among users as a “dry hit” where the wick is being burned without vaporizing the liquid/oil), 4) alternative non-liquid vaporizing reservoirs may include the same form factor yet with a closed/built in grinder to make the particle size optimal for vaporization, 5) simple cartridge style assembly for easy to clean/remove old vaporized botanical/organic material.

Vaporizing reservoirs, and vaporizing systems including the vaporizing reservoirs, may be made more effective: 1) the ability for the vaporizing reservoirs to either be powered by standard direct electrical connection/current or by induction, for example, allows optimum treatment for a particular material, 2) induction uses less energy which may allow for longer battery life or allow use of a smaller, lighter battery, 3) in combination with a vaporizing system which uses a PWM (pulse width modulation) to better control temperature and the rate of vaporization for any particular material (and which may be tuned/adjusted for a particular material as the vaporizing reservoir is exchanged for another one having a different material with different optimization parameters.

A vaporizing reservoir, including a containment vessel including a first shaft port exposed to ambient and one or more sidewalls defining a body portion having an interior cavity and a vaporizing portion communicated to the interior cavity; an inductive coil disposed within the vaporizing portion, the inductive coil electrically disconnected outside of the containment vessel and configured for inductive heating; and an air shaft communicated to the vaporizing portion and extending to the first shaft port.

A vaporizing apparatus, including a housing defining a compartment having an opening and including a portable power source, a controller, and an activating inducting coil wherein the compartment supports the activating inducting coil; a closure moveably coupled to the housing and configured to close the opening, the closure including a mouthpiece portion defining an air passageway therethrough; and a containment vessel disposed within the compartment, the containment vessel including a first shaft port exposed to ambient and one or more sidewalls defining a body portion having an interior cavity and a vaporizing portion communicated to the interior cavity; an inductive coil disposed within the vaporizing portion and positioned inside the activating inducting coil, the inductive coil electrically disconnected outside of the containment vessel and configured for inductive heating by the activating inducting coil; and an air shaft communicated to the vaporizing portion and extending to the first shaft port; and wherein the first shaft port is aligned with the passageway when the closure closes the opening.

A vaporizing method for vaporizing a material disposed within an interior cavity of a body portion of a containment vessel, the material producing a vapor at about a gassing temperature, including a) communicating the material to an inductive coil disposed within the containment vessel; b) heating inductively the inductive coil to at least about the gassing temperature; c) producing an inhalation product from the material communicated to the heated inductive coil; and thereafter; d) extracting the inhalation product from an air shaft in communication with the inductive coil.

A vaporizing reservoir, including a containment vessel including a first shaft port exposed to ambient and one or more sidewalls defining a body portion having an interior cavity and a vaporizing portion communicated to the interior cavity; a heating coil disposed within the vaporizing portion, the heating coil electrically coupled to a power source outside of the containment vessel and configured for direct heating; and an air shaft communicated to the vaporizing portion and extending to the first shaft port.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a conventional vaporizer that includes an elongate housing that secures a battery, a switch, an atomizer, and a cartridge;

FIG. 2 illustrates a vaporizer embodiment of the present invention;

FIG. 3 illustrates an embodiment of a vaporizer with an unloaded vaporizing reservoir;

FIG. 4 illustrates the embodiment of FIG. 3 having the vaporizing reservoir loaded into the vaporizer;

FIG. 5 illustrates a retail embodiment of a vaporizing reservoir including a decorative tamper evident closure;

FIG. 6 illustrates a retail embodiment of a vaporizing reservoir including a decorative tamper evident closure;

FIG. 7 illustrates a perspective view of an exploded internal layout of a vaporizer;

FIG. 8 illustrates a front schematic view of an internal layout of the vaporizer of FIG. 7;

FIG. 9 illustrates a side schematic view of the internal layout of the vaporizer of FIG. 7;

FIG. 10 illustrates a sectional view of the internal layout of the vaporizer of FIG. 7;

FIG. 11 illustrates a bottom view of the internal layout of the vaporizer of FIG. 7;

FIG. 12 illustrates a sectional view of the internal layout of the vaporizer of FIG. 7;

FIG. 13 illustrates a front schematic view of an external layout of a portion of a vaporizer;

FIG. 14 illustrates a side schematic view of the external layout of the portion of the vaporizer illustrated in FIG. 13;

FIG. 15 illustrates a sectional view of the portion of the vaporizer illustrated in FIG. 13;

FIG. 16 illustrates a sectional view of the portion of the vaporizer illustrated in FIG. 14;

FIG. 17 illustrates a view of a vaporizing reservoir;

FIG. 18 illustrates a view of a vaporizing reservoir including an intact end coil;

FIG. 19 illustrates a view of a vaporizing reservoir include a divided end coil;

FIG. 20 illustrates a perspective view of a flower grinder implementation for a vaporizing reservoir;

FIG. 21 illustrates an exploded view of the flower grinder of FIG. 20;

FIG. 22 illustrates a retail package including an alternative vaporizing reservoir;

FIG. 23 illustrates a sectional view of the retail package illustrated in FIG. 22;

FIG. 24 illustrates an alternative vaporizer that operates with the alternative vaporizing reservoir illustrated in FIG. 22; and

FIG. 25 illustrates a sectional view of the alternative vaporizer illustrated in FIG. 24.

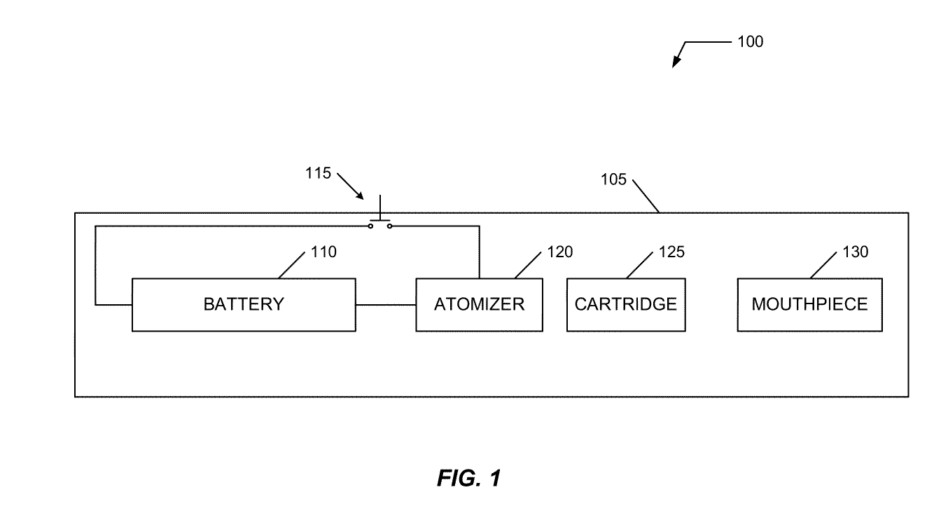

### DETAILED DESCRIPTION OF THE INVENTION

Embodiments of the present invention provide a system and method for a user experience with respect to vaporizers and the like. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

### DEFINITIONS

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following definitions apply to some of the aspects described with respect to some embodiments of the invention. These definitions may likewise be expanded upon herein.

As used herein, the term “or” includes “and/or” and the term “and/or” includes any and all combinations of one or more of the associated listed items. Expressions such as “at least one of,” when preceding a list of elements, modify the entire list of elements and do not modify the individual elements of the list.

As used herein, the singular terms “a,” “an,” and “the” include plural referents unless the context clearly dictates otherwise. Thus, for example, reference to an object can include multiple objects unless the context clearly dictates otherwise.

Also, as used in the description herein and throughout the claims that follow, the meaning of “in” includes “in” and “on” unless the context clearly dictates otherwise. It will be understood that when an element is referred to as being “on” another element, it can be directly on the other element or intervening elements may be present therebetween. In contrast, when an element is referred to as being “directly on” another element, there are no intervening elements present.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “connect,” “connected,” and “connecting” refer to a direct attachment or link. Connected objects have no or no substantial intermediary object or set of objects, as the context indicates.

As used herein, the terms “couple,” “coupled,” and “coupling” refer to an operational connection or linking. Coupled objects can be directly connected to one another or can be indirectly connected to one another, such as via an intermediary set of objects.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

As used herein, material includes a substance and any supporting medium storing the material for non-combusted productization of an inhalable product—this product is typically referred to as a vapor and includes the product in gaseous state and/or suspension of finely comminuted solid particles or liquid droplets in a gas, including aerosols, mists, and the like. Material includes liquid and liquid-like, solid and semi-solid substances, compositions, mixtures, suspensions, combinations, and preparations including botanical, organic, and mineral elements.

In summary, some embodiments the present invention include a handheld device made up of an airway, a main body, a power control mechanism, a material delivery device, a material delivery device locking system and a power source. The device when operated introduces thru its power control mechanism and electronics, and electrical system energy from its power source, energy to a heating element which provides energy to cause materials introduced by a material delivery system (solid, liquid, or multiphase) to off gas or vaporize which will be vented though the airway.

The airway is made up by passageways though the device that allows the user to introduce a lower atmospheric pressure to one end and draw in air from outside the device. This airway will direct the air current passed the heating element and venting the vapor or gasses out the low pressure end. With the application of a conductive material to the airway the power control mechanism will measure the resistance change when it comes in to contact with another conductive surface which can be used to trigger the power control mechanism to start the heating cycle.

The main body provides housing and protection for the airway, the power control mechanism, the material delivery device, the material delivery device locking system and the power source. The main body is of such mechanical design that it will resist the gravitational force and the introduction of rotational motion when the device is placed on an incline plane no greater than 17 degrees above horizontal.

The power control mechanism may include a control board which by method of electronics controls the timing and the amount of power supplied to the heating element. This is accomplished with direct or indirect mechanical connections. The direct method is of a more traditional wiring methodology the indirect method is accomplished using inductive heating technology. The power control mechanism maintains settings which are selected by the user or input via other electronic communications which may include but is not limited to wired and wireless communications protocols. It also provides the user with operational feedback as it pertains to power levels, On/Off, operational settings via LCD display, LED light patterns, tactile feedback or an auditable sonic device.

The material delivery device is composed of a container that is heat tolerant. This container houses the material to be introduced to the heating element. Its design provides alignment groves in its surface as to provide surfaces for the heating element to reside. The groves allow the heating element to be secured to the container and held in a predetermined location. In the container design is of such shape that it can only be placed into the material delivery locking system in a singular orientation. This orientation will in the case of direct mechanical connections align the heating element which is secured to the container with mechanical contacts there by completing the power circuit. In the case of indirect connections the orientation is such that it aligns the container to the proper depth that will maximize the effects of induction heating of the element. The container houses a heating element that lies in direct contact with a wick that is saturated with a liquid. The wick thru capillary action will draws the liquid to the heating element where it is excited to the point of vaporization. A second container designed to introduce solids to the heating element contains a location for the material to be placed such that it lies in contact with the heating element also the container features design elements as above that aligns the container with mechanical contacts and or depth in relation to the induction heating coil as to maximize the heating effect. The wick is of a material that will induce capillary action when introduced to a liquid

The material delivery device locking system is of such a mechanical design that it only allows the container to be placed into it in a singular orientation which aligns it to, and in, the case of direct connections with mechanical contacts to complete the electric circuit in the case of indirect connection the locking system aligns and secures the container at the optimal location with the induction coil.

The power source includes a battery which is of a chemical makeup that is capable of being recharged via direct mechanical connection or induction methods also the power source may contain a traditional mechanical connection to the power source mechanism.

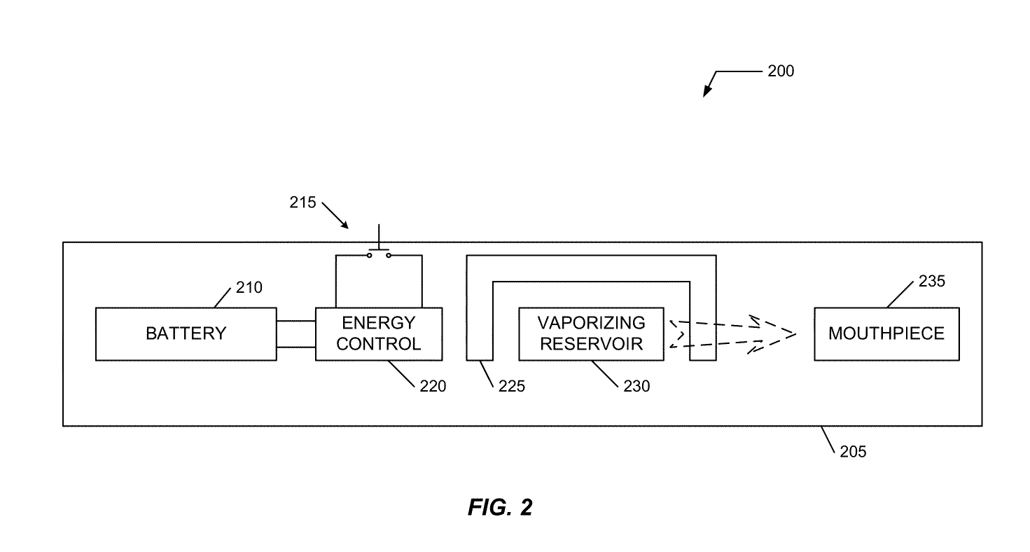

FIG. 2 illustrates a vaporizer 200 embodiment of the present invention. Vaporizer 200 includes a housing 205 having a battery 210, a switch 215, an energy control system 220, an energy delivery system 225, a vaporizing reservoir 230 and a mouthpiece 235. Housing 205 is preferably an elongate generally cylindrical structure but many other shapes and arrangements are possible. Housing 205 may be made of one or more polymers, metals, minerals, woods, composites, binder/aggregate mixtures, and combinations thereof. Battery 210 includes a portable energy storage device for storage, transportation, and/or delivery of electrical energy.

Switch 215 includes manual, automatic, and semi-automatic electrical components or assemblies that directly or indirectly influences an electrical energy processing of energy control system 220 (including diverting/directing current from battery 210 to energy control system 220). In some implementations, switch 215 may include one or more operational modes (including combinations) selected from: a user produces inhalable product from vaporizer 200 by actuating switch 215 directly (e.g., pressing it) or creating a pressure differential at mouthpiece 235 (e.g., inhaling through the mouthpiece), or actuating switch 215 while inhaling through mouthpiece 235.

Energy control system 220 includes any necessary or desirable electronics to generate one or more a desired energy patterns for operating energy delivery system 225. Vaporizer 200 includes a number of possible implementations (in some cases, the modes may be capable of coexisting in a single device while in other cases the modes are incompatible and vaporizer 200 will include just one of the incompatible modes). Representative possible modes may include, for example, an inductive mode and a direct heating mode. In the inductive mode, energy control system 220 produces and provides a sequence of energy pulses to energy delivery system 225. In this implementation, energy control system 220 may include pulse width modulation (PWM) to vary a duty cycle and effect certain predetermined properties of inhalable product that is produced from vaporizing reservoir 230. Energy control system 220 may in some cases include a processor or other stored program controller for accessing program instructions from a memory to produce the sequence of energy pulses. In a direct heating mode, energy control system 220 controls the energy pattern compatible with direct heating (e.g., an extended duration direct current pulse or other pattern).

Energy delivery system 225 is responsive to the energy pattern from energy control system 220 to activate a heating process in cooperation with vaporizing reservoir 230. This heating process produces the inhalable product from material contained within a cavity defined within vaporizing reservoir 230. Vaporizing reservoir 230 includes a material access structure (e.g., a wick assembly) disposed within the cavity and accessible through a single opening. The material access structure cooperates with energy delivery system 225 and becomes heated to produce the inhalable product through the opening.

For example, for the inductive mode, the material access structure includes one or more inductive-responsive structures responsive to the energy pulses and becomes inductively heated. The heated one or more structures produce the inhalable product. For the direct heating mode, the material access structure includes one or more heating coils that become heated in response to the energy pattern to produce the inhalable product from the material.

In the inductive mode, energy delivery system 225 may include, for example, one or more coils surrounding one or more desired portions of vaporizing reservoir 230 (and the material access structure). The energy pattern from energy control system 220 creates a particular magnetic field that induces heating in the inductive-responsive structures. This heating produces the inhalable product.

In the direct heating mode, energy delivery system 225 may include, for example, electrically conductive structures electrically communicated to the material access structure. The energy pattern from energy control system 220 heats the one or more coils. This heating produces the inhalable product.

Mouthpiece 235 is coupled to the single opening of vaporizing reservoir 230 and preferably an air-tight seal is produced such that the inhalable product generated from vaporizing reservoir 230 is available at an exit of mouthpiece 235. In some implementations, mouthpiece 235 defines an interior cavity that may be sized for pressurization effects in cooperation with vaporizing reservoir 230 (if necessary or desirable) and/or accumulation of a predefined quantity of inhalable product prior to delivery. In some of these implementations, it may be necessary or desirable to add a one-way valve at the exit to help with the pressurization and/or accumulation. Further, in some cases a one-way valve may be desired to inhibit undesirable/unintended venting of inhalable product from vaporizer 200 when not actively operated (e.g., inhaling through mouthpiece 235). Inhalable product is retained in the cavity of mouthpiece 235 until the one-way valve is opened (e.g., by manual switch and/or responsive to inhaling on mouthpiece 235 to create a pressure differential on opposing sides of the valve).

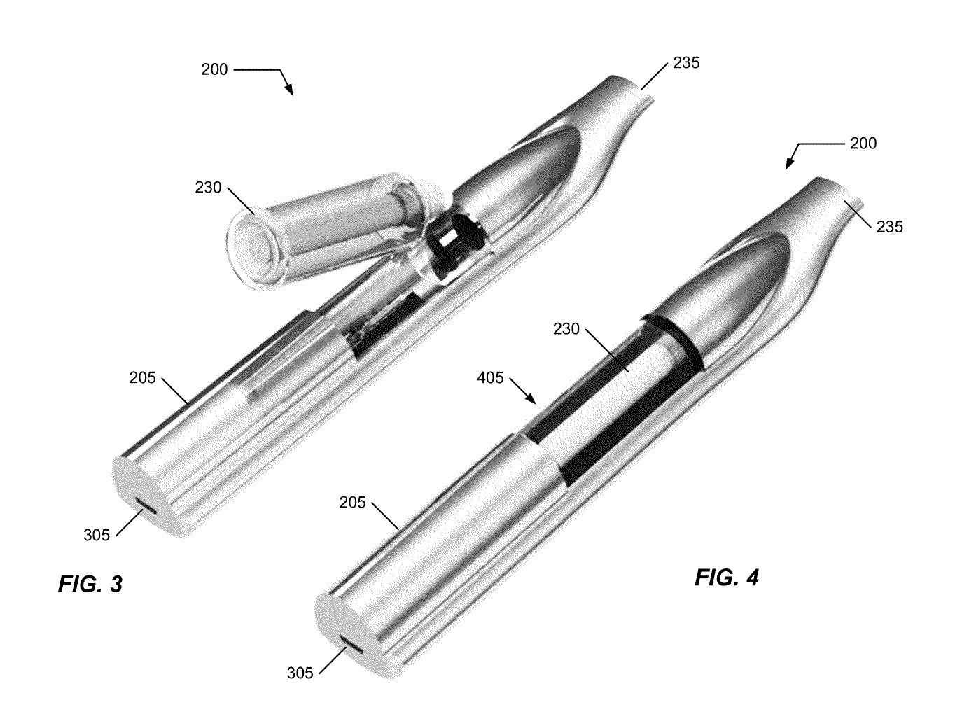

FIG. 3 illustrates an embodiment of vaporizer 200 with an unloaded vaporizing reservoir 230; and FIG. 4 illustrates the embodiment of FIG. 3 having vaporizing reservoir 230 loaded into vaporizer 200. Some implementations of vaporizer 200 include an exterior indicator 305 (e.g., an LED) that provides visible indication of operation of vaporizer 200 producing inhalable product. Indicator 305 is disposed at a distal end of housing 205 opposite of a proximal end supporting mouthpiece 235. Alternatively or in addition to exterior indicator 305, vaporizer 200 includes a recharging port 305 allowing a recharger to be plugged in and re-energize battery 210.

There are many different/possible mechanical interfaces supporting repeatable and sealable insertion and withdrawal of vaporizing reservoir 230 relative to housing 205. For example, as illustrated in FIG. 3 and FIG. 4, a mechanical interface may provide a spring-loaded mechanism which receives an opening end of a tilted vaporizing reservoir 230 (See FIG. 3). Pressure and rotation of vaporizing reservoir 230 allows vaporizing reservoir 230 to be axially aligned with housing 205 in which vaporizing reservoir 230 is sealed within housing and positioned correctly with respect to the energy delivery system and an air-tight seal formed with mouthpiece 235.

Alternative mechanisms may provide for a first portion of housing 205 supporting mouthpiece 235 to slide axially relative to a second portion of housing 205 supporting a reservoir receiving chamber 405. Sliding the first portion relative to the second portion expands and contracts an opening size of chamber 405 allowing vaporizing reservoir 230 to be inserted into the chamber when expanded and sealed within when contracted.

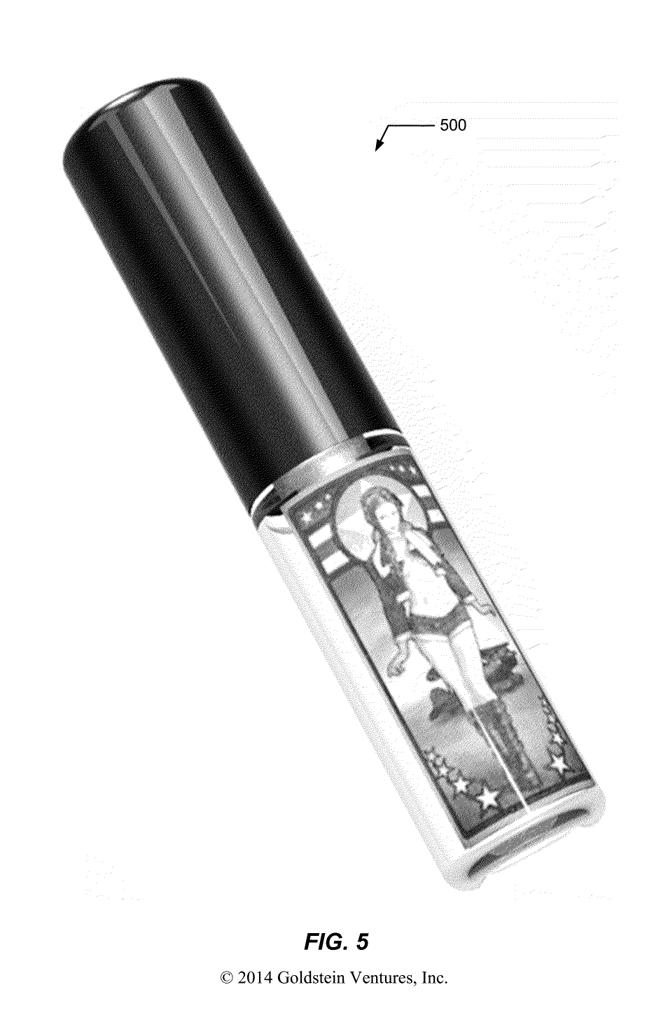

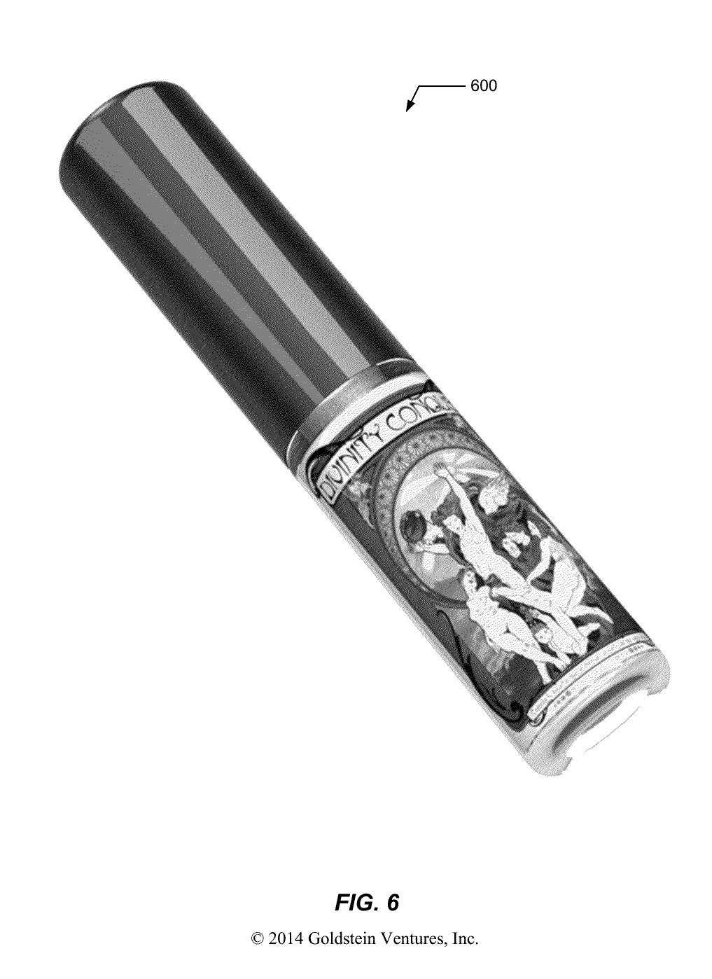

FIG. 5 illustrates a retail embodiment 500 of vaporizing reservoir 230 including a decorative tamper evident closure (e.g., a cap) 505 and FIG. 6 illustrates a retail embodiment 600 of vaporizing reservoir 230 including a decorative tamper evident closure (e.g., a cap) 605. The closure and/or the vaporizing reservoir may include decorative and/or informational graphics, images, or other content. In some implementations of a vaporizer, a portion of the vaporizing reservoir may be exposed in a receiving chamber and be visible during transportation and/or use. Branding and marketing opportunities are enabled by these elements, in addition to the security features of the tamper evident closure providing retailers and consumers of an indication of the quality of the material within the vaporizing reservoir.

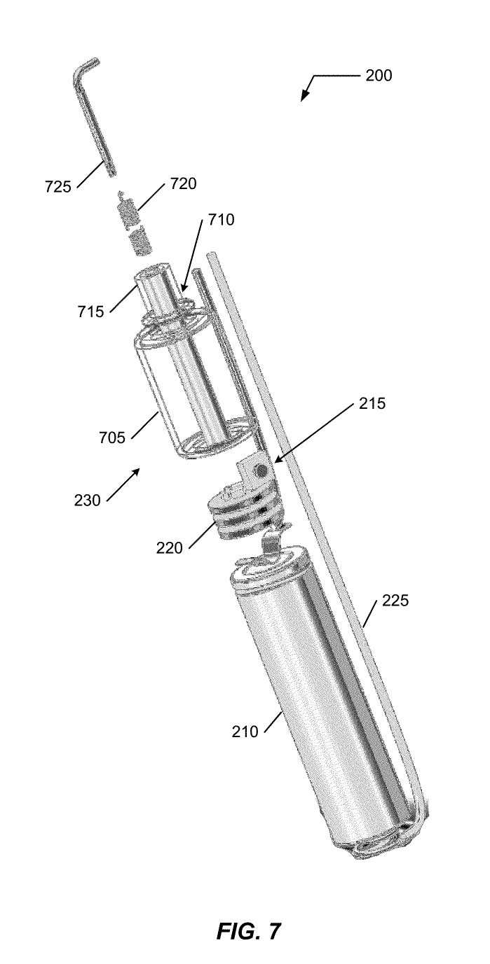

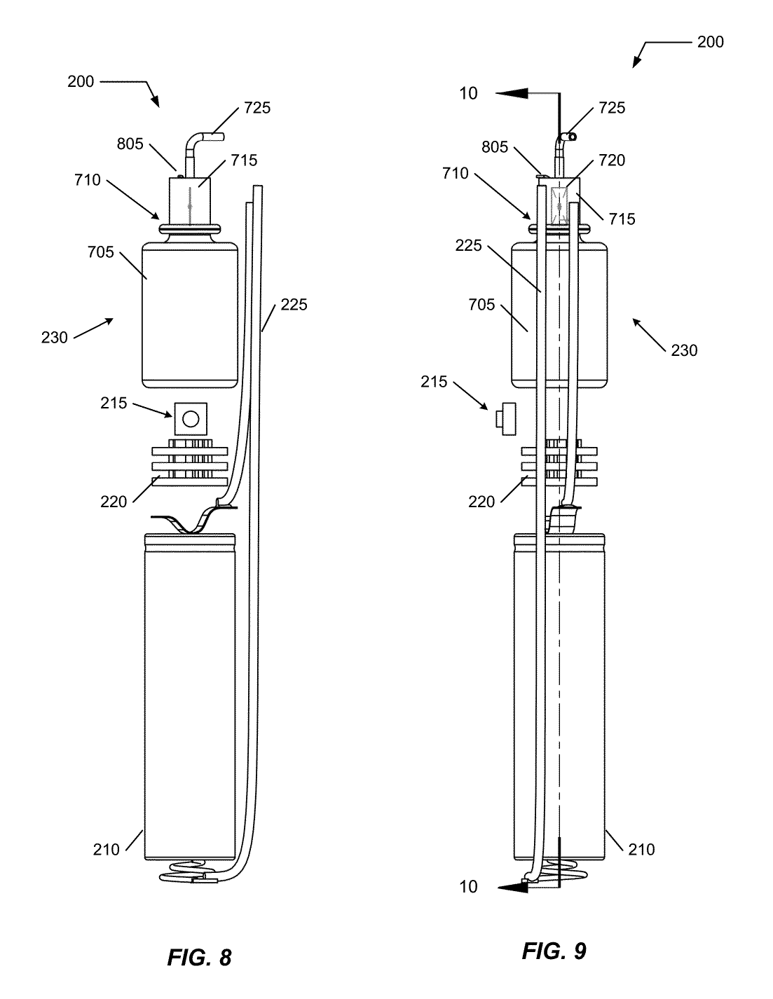

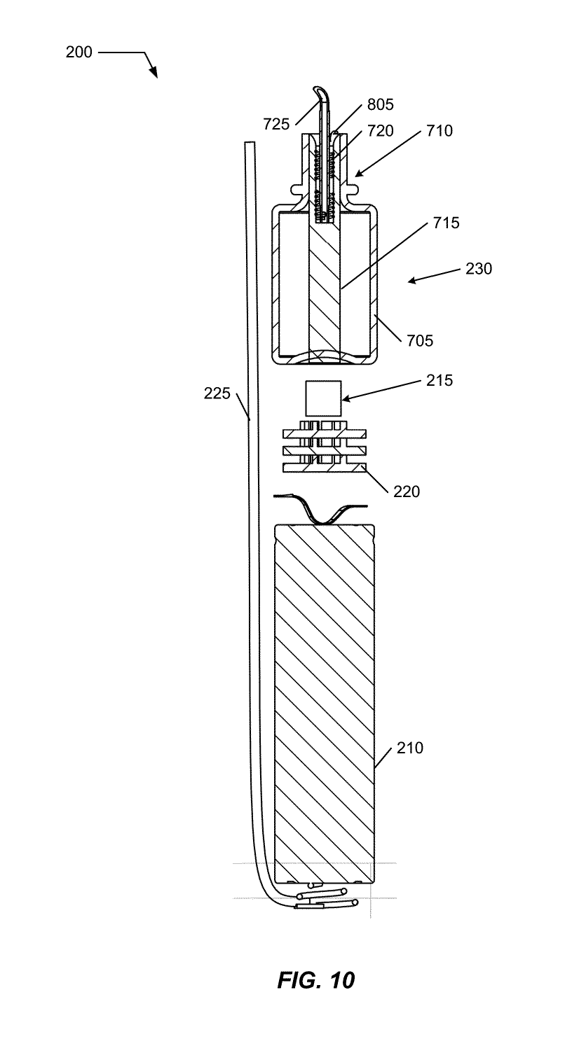

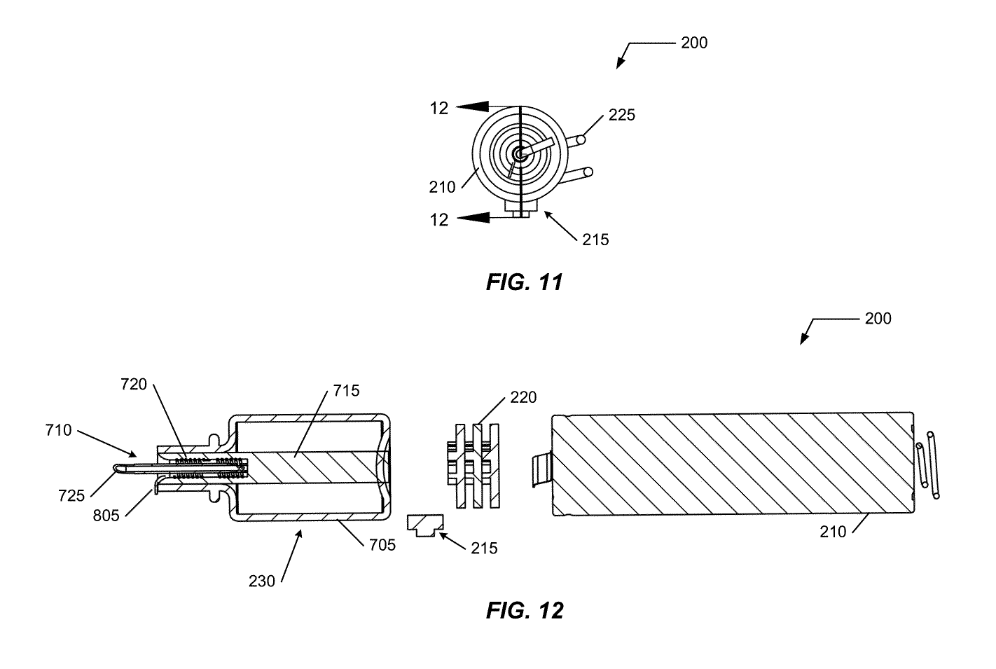

FIG. 7 illustrates a perspective view of an exploded internal layout of a portion of vaporizer 200 (without housing 205 and mouthpiece 235 for example), FIG. 8 illustrates a front schematic view of an internal layout of vaporizer 200 of FIG. 7, FIG. 9 illustrates a side schematic view of the internal layout of vaporizer 200 of FIG. 7, FIG. 10 illustrates a sectional view of the internal layout of vaporizer 200 of FIG. 7, FIG. 11 illustrates a bottom view of the internal layout of vaporizer 200 of FIG. 7, and FIG. 12 illustrates a sectional view of the internal layout of vaporizer 200 of FIG. 7. These views illustrate a non-specific implementation for energy delivery/heating and depict energy delivery system 225 as a pair of insulated metal conductors (e.g., wires) that may be coupled to an appropriate element (e.g., an external coil for an inductive implementation or coil connectors for a direct heating implementation).

Vaporizing reservoir 230 includes a bottle or other container 705 having a single opening 710 accessing an internal volume. The material access structure (e.g., a hollow wick 715) accesses the internal volume through opening 710. Hollow wick 715 includes a conductive structure 720 (e.g., a loop or coil) component. Some implementations may include a pressurization tube 725 (e.g., a hollow “L-shaped” tube) that accesses the internal volume through opening 710. FIG. 8 illustrates provision of a tab 805 that is electrically conductive and electrically communicated to conductive structure 720 for external access to conductive structure disposed within wick 715.

Container 705 is preferably generally cylindrical made from a transparent material but virtually any shape or construction material may be used. Transparency can aid an operator of vaporizer 200 with estimating a quantity of available material within the internal volume. Container 705 includes a closed bottom with sidewalls extending from the bottom to a top end that defines opening 710. In practice, for compatibility with vaporizer 200, a set of one or more standardized form factors can be established for vaporizing reservoir 230 that define a body shape (e.g., a length and a radius) a neck shape (e.g., a length and a radius) coupled to the body shape. These form factors will accurately locate vaporizing reservoir 230 within housing 205 sufficiently to enable energy delivery system 225 to cause wick 715 to heat material contained within the internal volume and produce inhalable product that in turn is drawn through mouthpiece 235 and used by an operator.

Wick 715 is a porous natural or synthetic material in which liquid contents of vaporizing reservoir 230 is drawn by capillary action towards opening 710. There are many different implementations of wick 715, some of which may desirably be tuned for particular material types. Wick 715 is easily tuned for a particular material in the embodiment illustrated in FIG. 7 because wick 715 is implemented as part of vaporizing reservoir 230 and is not intended to be reused with different materials.

Wick 715 preferably includes a hollow axial cavity that extends partially or fully along a length from outside opening 710 towards a bottom of container 705. Disposed within or around this hollow axial cavity is conductive structure 720. Conductive structure 720 may be discrete from, or integrated with, wick 715. Conductive structure 720 may include a coil of electrically conductive material.

In an inductive implementation of vaporizer 200, conductive structure 720 may be tuned for inductive heating responsive to a changing external field produced by energy delivery system 225 including a set of one or more external coils surrounding all or a portion of container 705.

In a direct heating implementation of vaporizer 200, conductive structure may be tuned much like a conventional heating coil in which opposing ends are coupled to energy provided by energy delivery system 225. As one end of such a coil may be available proximate opening 710 while the opposing end is disposed within wick 715, pressurization tube 725 may be made electrically conductive and be insulated from contacting the coil except at the opposing end disposed within wick 715.

In some implementations including vaporizing reservoir 230 with the preferred single opening 710 filled by wick 715, heating material and evacuating inhalable product produced by heating conductive structure may create a vapor lock or a negative pressurization that may in some circumstance prevent or inhibit inhalable product to be drawn out of container 705. Pressurization tube 725 is a representative solution in which one end is disposed within container 705 and another end is ported to ambient atmosphere pressure. An internal channel extends along a length of pressurization tube 725 from one end to the other. Any pressure imbalance within container 705 may be relieved by pressurization tube 725.

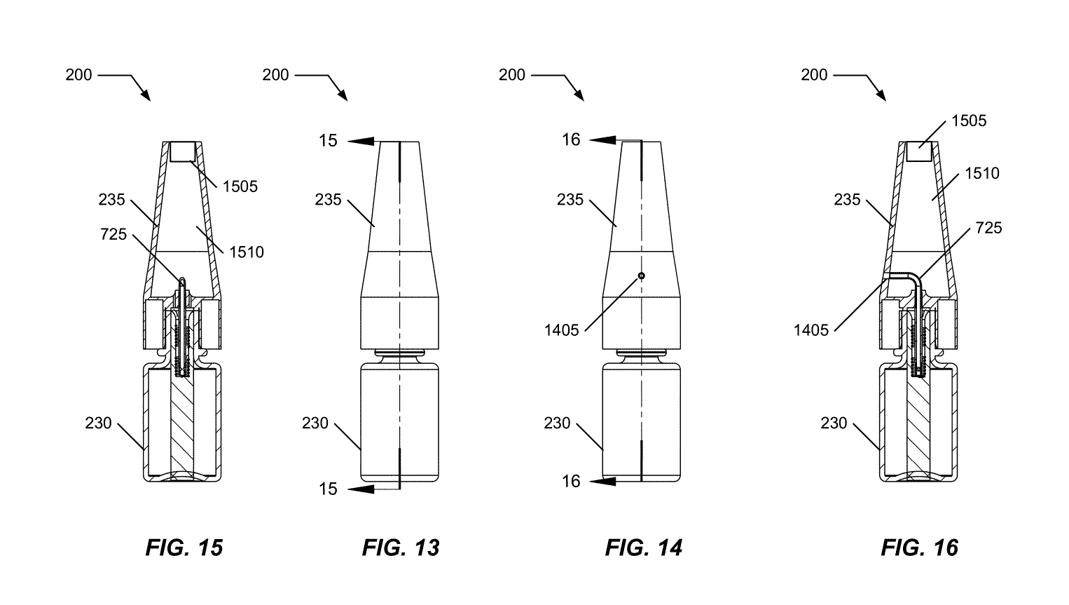

FIG. 13-FIG. 16 illustrate an external portion (e.g., mouthpiece 235 coupled to vaporizing reservoir 230) of vaporizer 200. FIG. 13 illustrates a front schematic view of an external layout of a portion of vaporizer 200, FIG. 14 illustrates a side schematic view of the external layout of the portion of vaporizer 200 illustrated in FIG. 13, FIG. 15 illustrates a sectional view of the portion of the vaporizer illustrated in FIG. 13, and FIG. 16 illustrates a sectional view of the portion of the vaporizer illustrated in FIG. 14. In addition to the details illustrated in FIG. 2-FIG. 12 and described herein, FIG. 13-FIG. 16 illustrate provision of an external port 1400 coupled to one open end of pressurization tube 725 coupling the internal volume of vaporizing reservoir 230 to ambient atmosphere surrounding vaporizer 200. Additionally, FIG. 13-FIG. 16 illustrate provision of a one-way valve 1505 (optional in some implementations) in mouthpiece 235 for selectively sealing a cavity 1510.

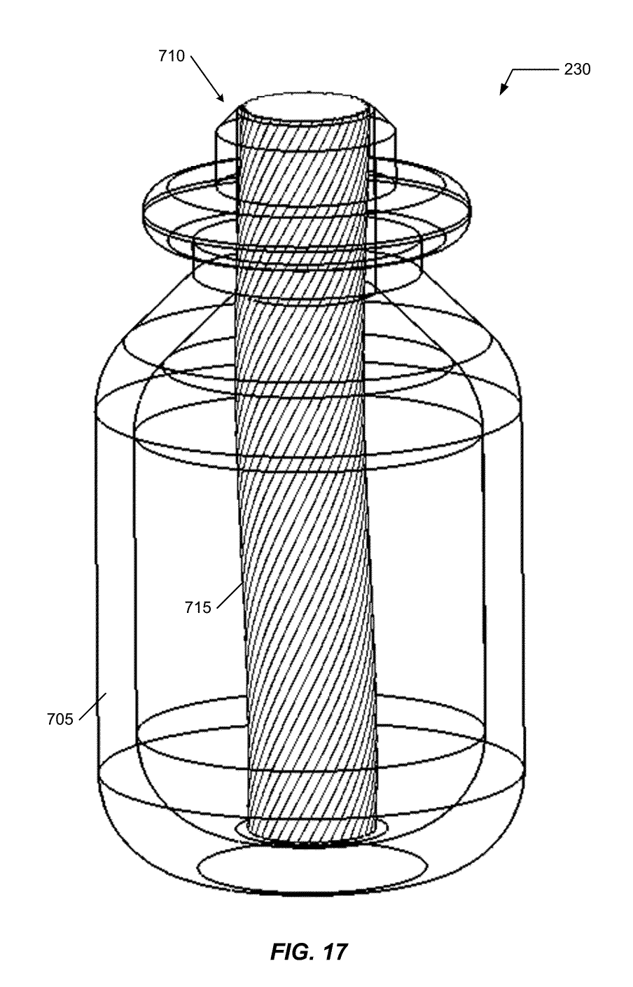

FIG. 17 illustrates a view of vaporizing reservoir 230 including container 705 defining an internal volume for holding material to be transformed into inhalable product, as well as the material access structure (e.g., wick 715 for liquid and liquid-like material) disposed into the internal volume through single opening 710. Each vaporizing reservoir includes: 1) a material access structure (e.g., a drawing wick) therein appropriately accessing and heating the material disposed within, and 2) an incorporated conductive structure (e.g., interwoven conductive coils into a wicking material). While different implementations may be optimized for different operational parameters, some implementations consider that a largest surface area of a conductive coil would be on outside surfaces. Thus the conductive structure (e.g., coil) may line, or be inserted into, an inner diameter of the material access structure (e.g., the drawing wick—the wick is a hollow tube as well) to optimize this parameter. That is, the larger the surface area of the coil in contact with the wick, the larger the vapor plumes created from the vaporizing reservoir will be. The hollow axial cavity in the material access structure in combination with the “L” shaped pressurization tube creates more free flow of air that allows air intake for the vaporizing reservoir during operation to reduce or eliminate creation of a persistent negative air pressure inside the internal air cavity that could interfere with formation/extraction of the inhalable product.

The energy system of the vaporizer includes: 1) inductive or direct electrical contact thereto or surrounding the material access structure (e.g., a wick); 2) a pressure equalization draw tube that may be also used as a negative lead contact for certain implementations using direct conductive current; 3) battery to power inductive coil or the coils of the wick; 4) pulse width modulation (PWM) energy pattern with metering adjustability responsive to an activation button/circuit board electronics (e.g., a toggle left right similar to other controls with button for On/Off) may also control inhalable product parameters (plume size, quantity, temperature, and other modifiable parameters); 5) inductive charging through recharging station or direct charging; and 6) comfort draw tip/mouth with optimal flow/venting/carbureting features.

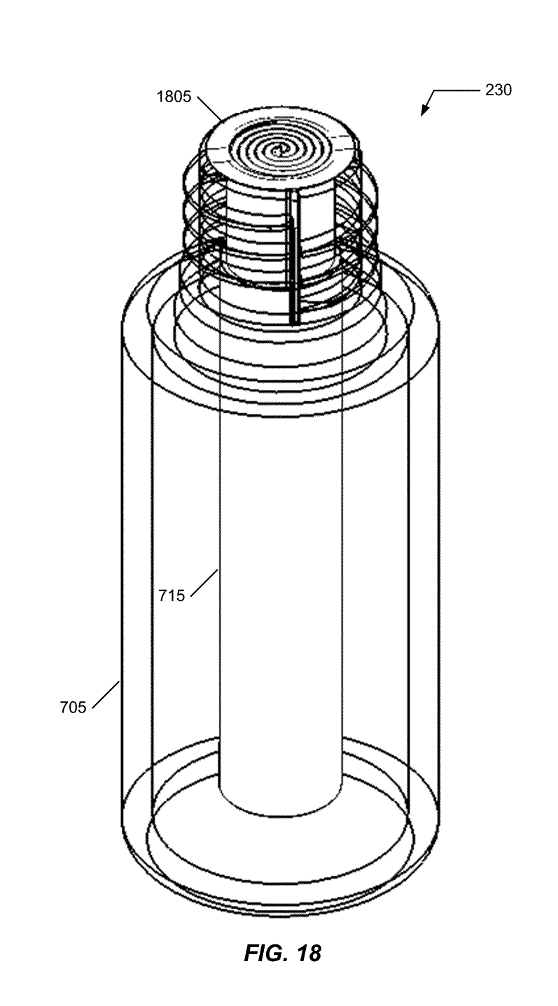

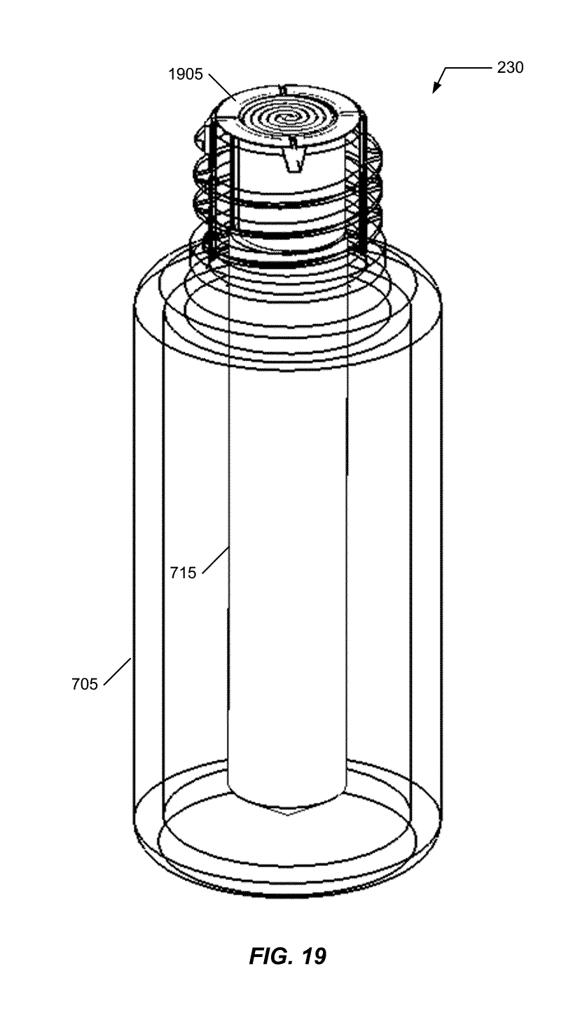

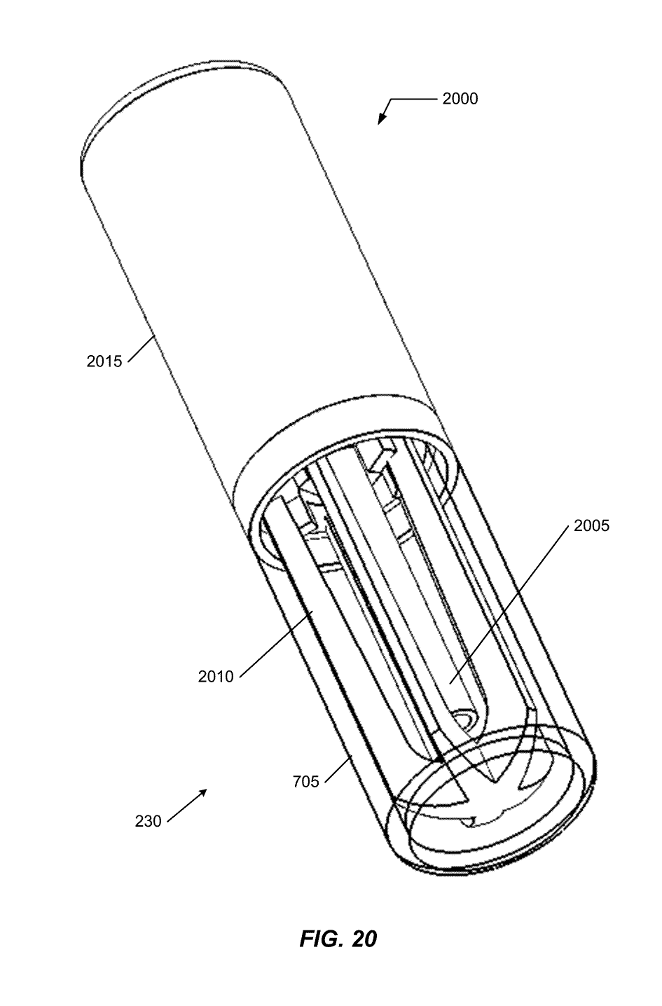

FIG. 18 illustrates a view of vaporizing reservoir 230 including an intact end structure 1805 as part of conductive structure 720 such as may be configured for an inductive heating implementation. Intact end structure 1805 is configured for responding to an energy pattern designed to induce inductive heating of conductive structure 720 and the closed loop arrangement improves upon that heating modality. Vaporizing reservoir 230 may be distributed/retailed with conductive structure 720 having intact end structure 1805 to enable a user-implemented option to convert to a direct heating modality by converting conductive structure 720 to that of FIG. 19.

FIG. 19 illustrates a view of a vaporizing reservoir include a divided end structure 1905 as part of conductive structure 720 such as may be configured for a direct heating implementation. Divided end structure 1905 is configured for responding to an energy pattern designed to induce direct heating of conductive structure 720 and the open loop arrangement improves upon that heating modality. Vaporizing reservoir 230 that is distributed/retailed with conductive structure 720 having intact end structure 1805 enable a user-implemented option to convert to a direct heating modality by converting conductive structure 720 to that of FIG. 19 and converting intact end structure 1805 to divided end structure 1905. In some implementations, vaporizer 200 designed for direct heating and compatible with vaporizing reservoir 230 may include a dividing mechanism to make this conversion, such as when installing vaporizing reservoir 230 into the receiving chamber.

A key to some illustrated designs of vaporizing reservoir 230 is that there is a ferrous (copper) foil tape “O” ring on a top edge of container 705 at the opening that can be broken (for example by fin features on a main body unit) to create negative and positive poles for direct electric vaporizing; or an unbroken foil tape ring on the top can just be inserted into the main body unit and be appropriately exposed to inductive coils for induction vaporization. The coil at the top of the material access structure is interwoven within, such as within the wicking material, so as to not cause an electrical short and is anticipated in many implementations to extend past the internal coil in order to guarantee no contact.

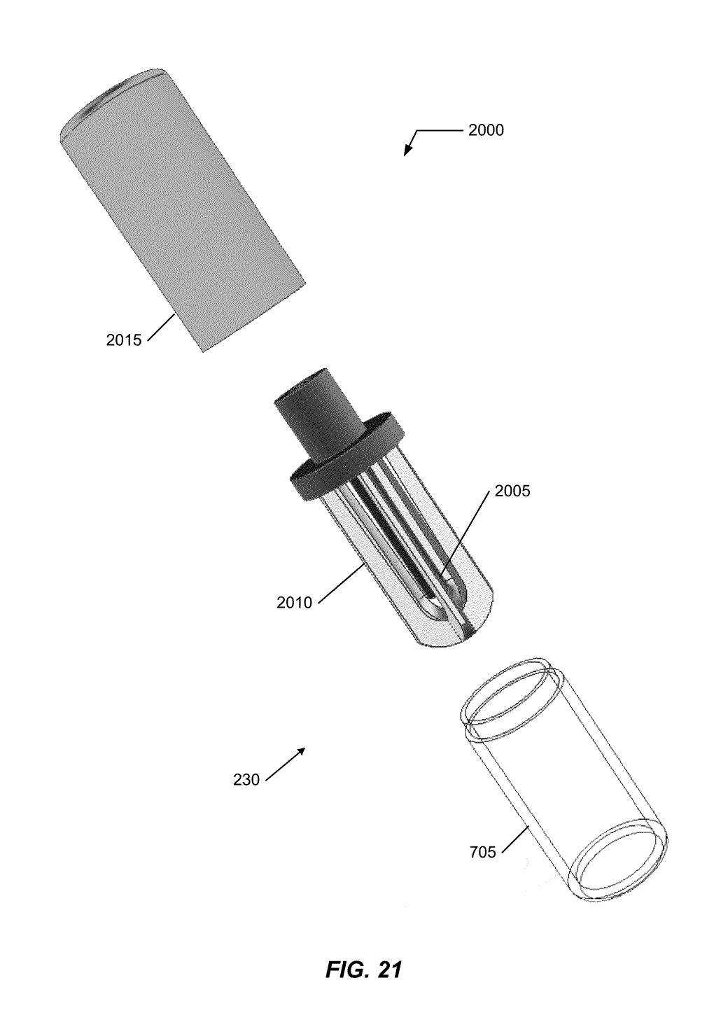

FIG. 20 illustrates a perspective view of a retail implementation 2000 of a grinder implementation for a vaporizing reservoir 230; and FIG. 21 illustrates an exploded view of retail implementation 2000. The grinder implementation is designed for material that is not liquid or liquid-like (i.e., capable of being transported by capillary action through a wicking structure) including materials such as, for example, botanical, organic, or solid/semi-solid material. Vaporizing reservoir 230 included as part of retail implementation 2000 is compatible mechanically and operationally with the other vaporizing reservoirs illustrated in FIG. 2-FIG. 19 and described herein.

Vaporizing reservoir 230 of retail implementation 2000 is illustrated with container 705 defining an internal volume accessed through a single opening and a material access structure 2005 disposed through the opening and extending into the internal volume. One or more user operable grinder blades 2010 are also disposed in the internal volume for comminution of the material within container 705. A tamper evident closure 2015 is optionally provided. Material access structure 2005 may include a ferrous rod connected with a non-conductive cap of porcelain/ceramic or plastic for vaporizing the material responsive to the energy delivery system. In some implementations, an embodiment may include foil tape and coils (and may be implemented as a retrofit solution for compatible existing vaporizing reservoirs 230 configured for grinding) for a direct electrical connection modality for direct heating vaporization.

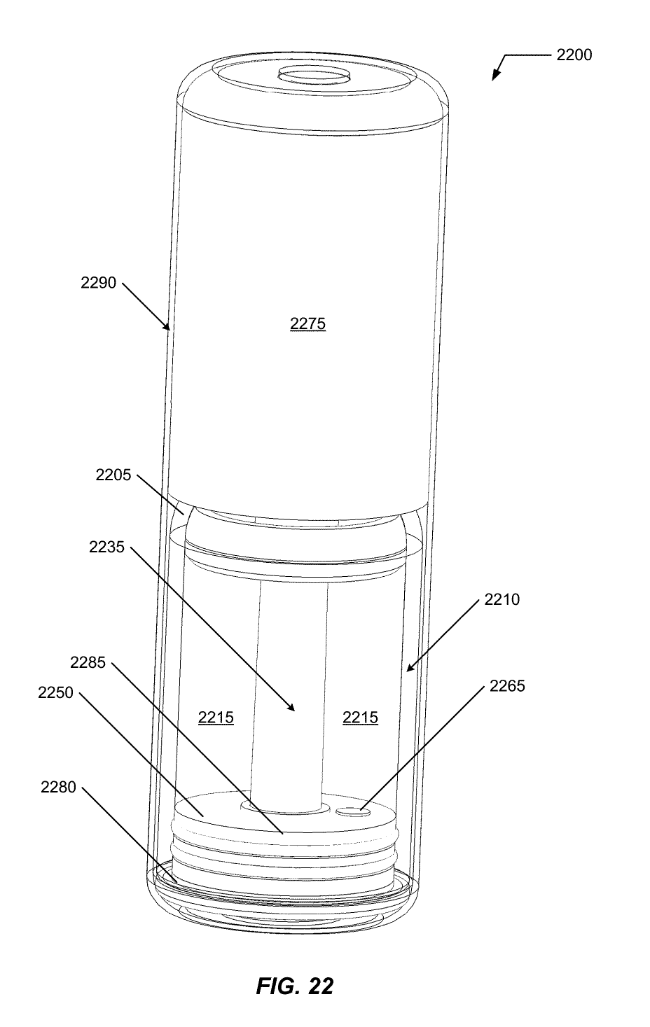

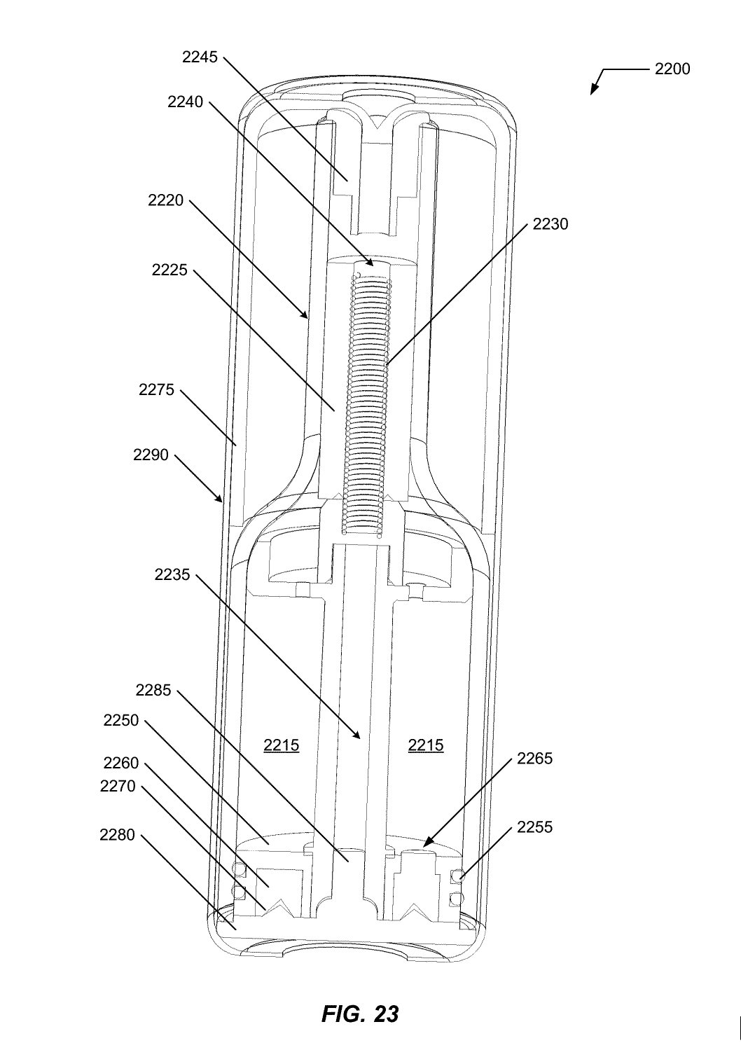

FIG. 22 illustrates a retail package 2200 including an alternative vaporizing reservoir 2205. FIG. 23 illustrates a sectional view of retail package 2200. General configuration, arrangement, and operation of vaporizing reservoir 2205 is consistent with the description of the applicable portions of corresponding elements illustrated in FIG. 2-FIG. 21 and the associated description herein, except as contrary configuration, arrangement, and/or operation is explicitly or inherently presented. For example, an air flow path exists for vaporizing reservoir 2205 that passes completely therethrough as is further described.

Vaporizing reservoir 2205 includes a container portion 2210 that defines an interior cavity 2215 that may be used to store material for vaporization, and a neck portion 2220 extending from container portion 2210. As illustrated, interior cavity 2215 is generally shaped as an annular cylinder though other perimeter shapes may be used instead of a circle, including regular and irregular polygonal shapes and other curvilinear perimeters including elliptical perimeters. Neck portion 2220 includes a vaporizing wick 2225 that includes an induction coil 2230. Vaporizing wick 2225 is in communication with interior cavity 2215.

A center airway shaft 2235 is disposed within interior cavity 2215. Wick 2225 and coil 2230 define a center airway shaft 2240 within neck portion 2220. Shaft 2235 and shaft 2240 provide a center airway shaft completely through vaporizing reservoir 2205 from a base of container portion 2210 to an end of neck portion 2220.

A neck plug 2245 seals the end of neck portion 2220 and a container plug 2250 seals the base of container portion 2210. One or more seals 2255 (e.g., O-rings and the like) may be used to improve a seal of container plug 2250 with respect to the base of container portion 2210.

A 360 degree insert 2260 engages container plug 2250 that allows access into interior cavity 2215 through a port 2265. Port 2265 is closed and sealed when insert 2260 is inserted into container plug 2250. An exterior surface, when installed into container plug 2250, of insert 2260 includes a 360 degree groove 2270 (illustrated as a V shaped groove though other groove profiles may be employed).

In some embodiments, insert 2260 is user-replaceable to allow user refilling/adding material into interior cavity 2215 while other embodiments may secure insert 2260 to container plug 2250 to inhibit user access to interior cavity 2215.

Retail package 2200 further includes a resealable cap 2275 that may include internal fins or other mechanical structures to mate to neck portion 2220 and secure cap 2275 to vaporizing reservoir 2205. Retail package 2200 may further include a bottom plate 2280 to engage container plug 2250 (which may include mating structures complementary to the groove profile and an airway shaft plug portion 2285 to help seal vaporizing reservoir 2205 during shipment, storage, display, and/or carry operations).

Retail package 2200 may further include tamper evident closure systems, such as a shrink wrap 2290 sealing cap 2275 to vaporizing reservoir 2205. Alternatively, tamper evident tape or the like may be applied to a junction of cap 2275 and vaporizing reservoir 2205.

Plug portion 2285 may define an extended rod, pin, cable, filament, or the like that extends through the center airshaft to engage neck plug 2245 and/or cap 2275 to hold retail package closed or for enhanced seal to constrain the material within interior cavity 2215 without leakage.

Vaporizing reservoir 2205 is illustrated for operation in an “upside down” or inverted arrangement in which neck portion 2220 is below container portion 2210. An advantage of such an arrangement is that material in container portion 2210 is aided by gravity to contact wick 2225 during use. This assistance helps minimize unused material in vaporizing reservoir 2205.

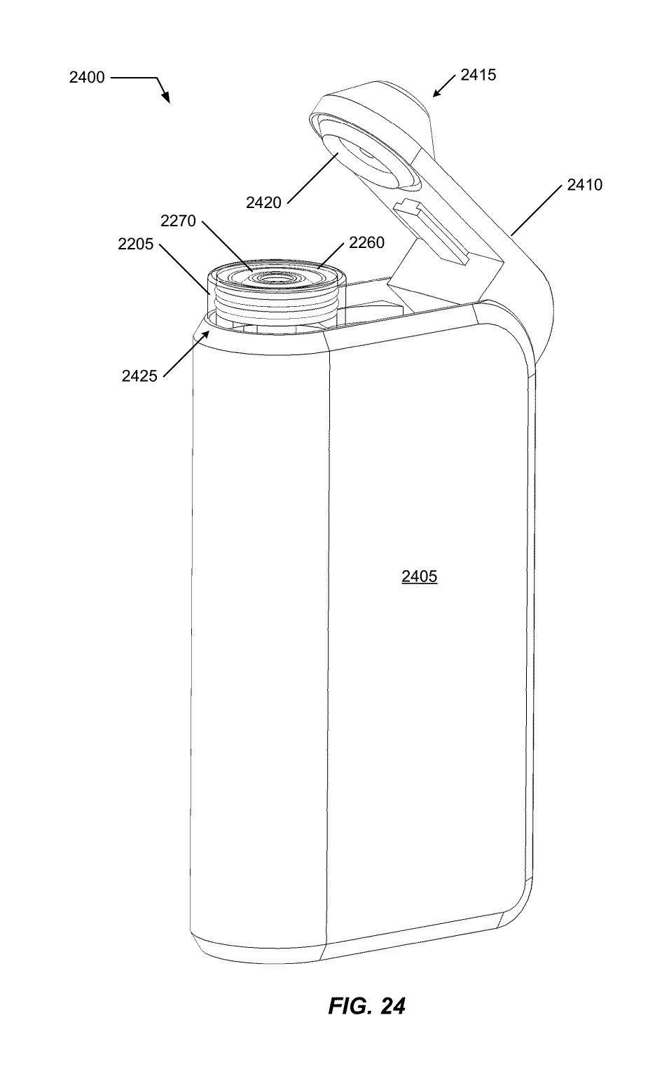

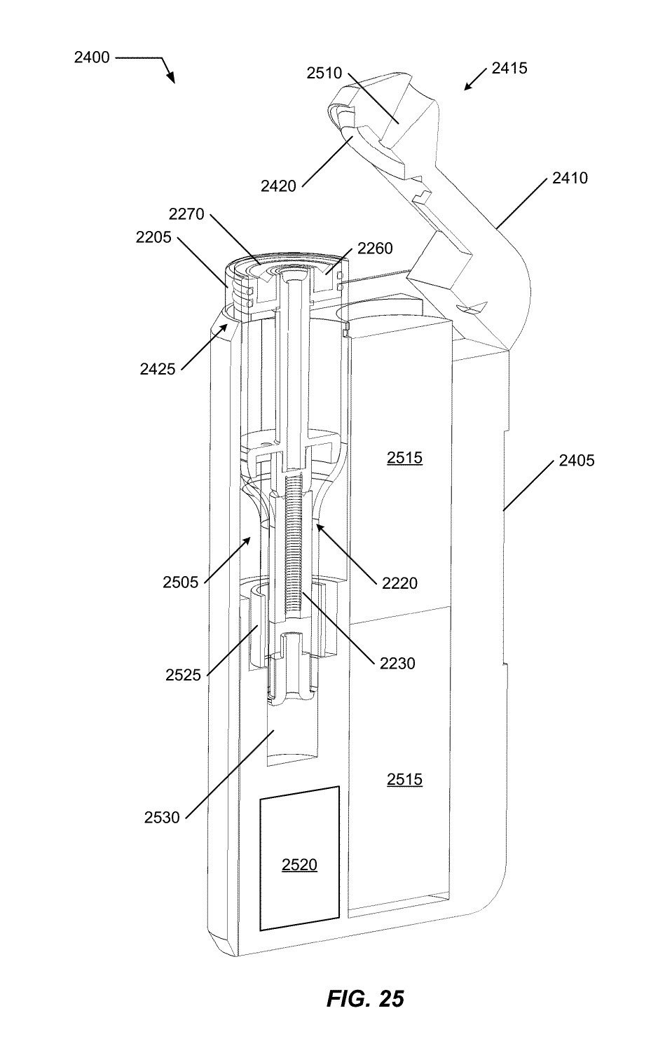

FIG. 24 illustrates an alternative vaporizer 2400 that operates with the alternative vaporizing reservoir 2205 illustrated in FIG. 22; and FIG. 25 illustrates a sectional view of alternative vaporizer 2400 with vaporizing reservoir 2205 partially installed. As noted herein, vaporizer 2400 is arranged so that vaporizing reservoir 2205 is inverted during operation. During operation and loading of vaporizing reservoir 2205, plugs and seals of the central air shaft extending through vaporizing reservoir 2205 are removed.

Vaporizer 2400 includes a housing 2405 having a closure 2410, for example a hinged door or other moveable user-operable access mechanism. Closure 2410 includes a mouthpiece portion 2415 that includes a 360 degree mouthpiece seal 2420 that is cooperative and complementary to groove 2270 in insert 2260. When vaporizing reservoir 2205 is inverted and positioned within an interior compartment 2505, groove 2270 is exposed at an opening 2425 accessing compartment 2505. Closure 2410 may be transitioned to a closed position for operation which engages mouthpiece seal 2420 against groove 2270 for a 360 degree seal around the central air shaft of vaporizing reservoir 2205. Mouthpiece portion 2415 includes a passageway 2510 aligned with the unobstructed central air shaft of the installed vaporizing reservoir 2205 when closure 2410 is shut. Output produced by vaporizer 2400 may be accessed, e.g., inhaled or the like, through passageway 2510. The mutual seal of mouthpiece seal 2420 with groove 2270 inhibits output from exiting through closure 2410 except through passageway 2510.

Inside housing 2405 are other components of a vaporizing unit such as those described herein. One or more batteries 2515 provide operating power, including to a controller 2520 for setting operating parameters, such as for example, a vaporizing temperature for material within vaporizing reservoir 2205, of vaporizer 2400. Typically some user interface is provided to provide user information and control function as described herein. Positioned on housing 2405 may be an actuator switch, which may be part of the user interface, to trigger manual operation of vaporizer 2400. As noted herein, an automatic trigger may also, or in lieu of the actuator switch, may be included to respond to negative air pressure in passageway 2510, or the like. Negative pressure may result, for example, when closure 2410 is shut and a user places lips over mouthpiece portion 2415 to form an air seal and draws air from passageway 2510.

Controller 2520 is coupled to an inductor coil 2525 disposed within compartment 2505 and positioned to surround neck portion 2220 of vaporizing reservoir 2205. When vaporizing reservoir 2205 is fully installed into compartment 2505, coil 2230 is generally centered within inductor coil 2525 (coil 2230 is illustrated as being longer than a height of inductor coil 2525 which improves operation).

A chamber portion 2530 at a bottom of compartment 2505 is communicated to ambient, such as through an air inlet or port. Chamber portion 2530 may include air baffles and/or a spring-loaded ejection mechanism to help remove vaporizing reservoir 2205 from compartment 2505.

In operation, a user removes vaporizing reservoir 2205 from retail package 2200, which may include removing tamper evident shrink-wrap, tape, or the like, and removing cap 2275. All plugs and seals of the central air shaft are removed. In some instances, a user may add material into interior cavity 2215 by removing insert 2260 to open port 2265. An amount of material in interior cavity 2215 is controlled through port 2265 when available to the user, allowing the user to add or remove product.

Vaporizing reservoir 2205 is inverted, allowing material to contact wick 2225, and placed into compartment 2505. Vaporizing reservoir 2205 is positioned within compartment 2505 such that coil 2230 is within inducting coil 2525 and closure 2410 is closed. Passageway 2510 is aligned with the unobstructed central air shaft of vaporizing reservoir 2205 and sealed using 360 degree mouthpiece seal 2420 engaging groove 2270.

When desired, the user activates inducting coil 2525 to induce heating of coil 2230 within wick 2225 according to a heating profile established by controller 2520. (Inductive heating may permit a greater and more fine-grained temperature profile than other heating modalities.) The heated coil 2230 vaporizes nearby material, e.g., fluid material disposed within wick 2225, the vapor made available within the central air shaft.

The user extracts vapor from within the central air shaft through sealed passageway 2510 without leakage.

When operation is to conclude, the user may power down vaporizer 2400 and store vaporizing reservoir within compartment 2505. In other cases, the user may open closure 2410 and extract vaporizing reservoir from within compartment 2505 through opening 2425.

Desired air shaft plugs and seals may be installed, and resealable cap 2275 positioned over neck portion 2220 to close vaporizing reservoir 2205.

The system and methods above has been described in general terms as an aid to understanding details of preferred embodiments of the present invention. In the description herein, numerous specific details are provided, such as examples of components and/or methods, to provide a thorough understanding of embodiments of the present invention. For example, as illustrated, some embodiments may include a generally cylindrical body portion coupled to an elongate generally cylindrical neck portion, with a cylindrical central air shaft passing therethrough. A coil, intended to be heated inductively by a companion device, often a vaporizer, may be positioned within the neck portion and communicated to any material within the body portion, such as for example by gravity. The cross section profiles of the portions may be virtually any shape and it may be the case that the neck portion cross section more closely matches (e.g., diameter) the cross section of the body portion than illustrated herein. In some instances, it may be possible to integrate a vaporizing reservoir directly into a vaporizer so that it is not generally removable/replaceable. This may possible because an access port is available at an opening, for example. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A vaporizing reservoir, comprising:
a containment vessel including a first shaft port exposed to ambient and one or more sidewalls defining a body portion having an interior cavity and a vaporizing portion communicated to said interior cavity;
an inductive coil disposed within said vaporizing portion, said inductive coil electrically disconnected outside of said containment vessel and configured for inductive heating; and
an air shaft communicated to said vaporizing portion and extending to said first shaft port.

2. The vaporizing reservoir of claim 1 further comprising a second shaft port exposed to ambient wherein said air shaft extends from said vaporizing portion to said second shaft port.

3. The vaporizing reservoir of claim 2 wherein said body portion includes a base defining said second shaft port, wherein said vaporizing portion includes a neck portion having an end defining said first shaft port, wherein said end is opposite of said base, and wherein said air shaft extends from said base to said end.

4. The vaporizing reservoir of claim 3 wherein said air shaft extends along a central longitudinal axis of said containment vessel from said base to said end and wherein said base includes a sealing insert having a sealing structure centered around said air shaft.

5. The vaporizing reservoir of claim 4 wherein said base includes an access port communicated to said interior cavity and wherein said insert includes a plug portion complementary to said access port and configured to seal said access port with a fluid-tight seal.

6. The vaporizing reservoir of claim 1 wherein said vaporizing portion includes a wick coupled to said inductive coil.

7. The vaporizing reservoir of claim 2 wherein said vaporizing portion includes a wick coupled to said inductive coil.

8. The vaporizing reservoir of claim 3 wherein said vaporizing portion includes a wick coupled to said inductive coil.

9. The vaporizing reservoir of claim 4 wherein said vaporizing portion includes a wick coupled to said inductive coil.

10. The vaporizing reservoir of claim 5 wherein said vaporizing portion includes a wick coupled to said inductive coil.

11. A vaporizing apparatus, comprising:
a housing defining a compartment having an opening and including a portable power source, a controller, and an activating inducting coil wherein said compartment supports said activating inducting coil;
a closure moveably coupled to said housing and configured to close said opening, said closure including a mouthpiece portion defining an air passageway therethrough; and
a containment vessel disposed within said compartment, said containment vessel including a first shaft port exposed to ambient and one or more sidewalls defining a body portion having an interior cavity and a vaporizing portion communicated to said interior cavity;
an inductive coil disposed within said vaporizing portion and positioned inside said activating inducting coil, said inductive coil electrically disconnected outside of said containment vessel and configured for inductive heating by said activating inducting coil; and
an air shaft communicated to said vaporizing portion and extending to said first shaft port; and
wherein said first shaft port is aligned with said passageway when said closure closes said opening.

12. The vaporizing apparatus of claim 11 further comprising a second shaft port exposed to ambient wherein said air shaft extends from said vaporizing portion to said second shaft port.

13. The vaporizing apparatus of claim 12 wherein said body portion includes a base defining said second shaft port, wherein said vaporizing portion includes a neck portion having an end defining said first shaft port, wherein said end is opposite of said base, and wherein said air shaft extends from said base to said end.

14. The vaporizing apparatus of claim 13 wherein said air shaft extends along a central longitudinal axis of said containment vessel from said base to said end and wherein said base includes a sealing insert having a sealing structure centered around said air shaft and wherein said mouthpiece portion includes a mouthpiece seal configured to engage said sealing structure when said closure is closed to provide a gas-tight seal.

15. The vaporizing apparatus of claim 14 wherein said base includes an access port communicated to said interior cavity and wherein said insert includes a plug portion complementary to said access port and configured to seal said access port with a fluid-tight seal.

16. The vaporizing apparatus of claim 11 wherein said vaporizing portion includes a wick coupled to said inductive coil.

17. The vaporizing apparatus of claim 12 wherein said vaporizing portion includes a wick coupled to said inductive coil.

18. The vaporizing apparatus of claim 13 wherein said vaporizing portion includes a wick coupled to said inductive coil.

19. The vaporizing apparatus of claim 14 wherein said vaporizing portion includes a wick coupled to said inductive coil.

20. The vaporizing apparatus of claim 15 wherein said vaporizing portion includes a wick coupled to said inductive coil.

21. A vaporizing method for vaporizing a material disposed within an interior cavity of a body portion of a containment vessel, the material producing a vapor at about a gassing temperature, comprising the steps of:
a) communicating the material to an inductive coil disposed within the containment vessel;
b) heating inductively said inductive coil to at least about the gassing temperature;
c) producing an inhalation product from the material communicated to said heated inductive coil; and thereafter;
d) extracting said inhalation product from an air shaft in communication with said inductive coil.

22. A vaporizing reservoir, comprising:
a containment vessel including a first shaft port exposed to ambient and one or more sidewalls defining a body portion having an interior cavity and a vaporizing portion communicated to said interior cavity;
a heating coil disposed within said vaporizing portion, said heating coil electrically coupled to a power source outside of said containment vessel and configured for direct heating; and
an air shaft communicated to said vaporizing portion and extending to said first shaft port.
